(19) United States
(12) Patent Application Publication
(10) Pub. No.: US 2026/0338220 A1
(43) Pub. Date: Oct. 29, 2026

(54) THREAD FORM FOR A THREADED CONNECTION USING TWO DIFFERENT MATERIALS

(71) Applicant: ArvinMeritor Technology, LLC, Troy, MI (US)

(72) Inventors: Christopher WITTRY, Saint Clair Shores, MI (US); Prathap N. KRISHNAN, Bangalore (IN); Ashwini BHARATH, Bengaluru (IN); Mahesha SHIVANNA, Bengaluru (IN); Michael WESSEL, Batesville, IN (US); Chinmaya CHANDRASHEKHAR, Shivamogga (IN)

(21) Appl. No.: 19/191,977

(22) Filed: Apr. 28, 2025

(51) Int. Cl. F16B 39/30; B01D 53/26

(52) U.S. Cl. CPC F16B 39/30; B01D 53/26; B01D 2201/4092

(57) ABSTRACT

A thread form of a first plurality of threads of a first threaded member for theaded connection with a second plurality of threads of a second threaded member is described. The first plurality of threads has a pitch, P, and each thread of the first plurality of threads includes a crest between a pair of flanks. In an embodiment, for each thread of the first plurality of threads, a load-bearing flank of the pair of flanks is configured to bear against a mating flank of one of the second plurality of threads and comprises a surface having a first radius, R1, where 0.67≤R1/P≤0.80. In another embodiment, an area ratio AG/AT>0.83, where AG and AT are respectively a cross-sectional area of each gap between, and a cross-sectional area of each thread of, the first plurality of threads.

### FIELD

The present disclosure concerns threaded connections and, in particular, to a thread form for use in threaded connections in which materials of two different strengths are used.

### BACKGROUND

Threaded connections are known in the art. Threads employed in such connections can be formed, for example, using the well-known metric ISO (International Organization for Standardization) standard thread.

With conventional threaded connections, the use of materials of different strengths for the male threads and female threads can result in damage to the threaded part formed from the lower-strength material when the threaded connection is overtightened. For this reason, it is standard practice for technical specifications to include the highest permissible tightening torques for threaded connections in order to avoid damage. In many cases, however, such as, for example, when replaceable cartridges are being screwed on, as in the case of air dryers in compressed-air brake systems for commercial vehicles, or even oil filters, it is standard practice to tighten the threaded connection by hand, without using a pre-adjustable torque wrench. Also, it is generally desirable in other applications of threaded connections to prevent accidental damage, such as can occur due to incorrect adjustment of a torque wrench or inadvertent failure to use a torque wrench.

A non-limiting example of such a threaded connection in the context of a replaceable cartridge 102 is illustrated in FIGS. 1-3. In particular, FIGS. 1 and 2 illustrate components of an air dryer system 100 of the type often found in compressed-air brake systems for commercial vehicles. The system include an air dryer cartridge 102 mounted to a compressed-air system component 104. As known in the art, and as best illustrated in FIG. 2, the air dryer cartridge 102 comprises a desiccant assembly 202 supported by a cartridge mounting plate 204 and enclosed by a cartridge housing 206 that may be affixed to mounting plate 204. The desiccant assembly 202 includes materials that dry out air supplied to the cartridge 102. Though not shown in FIG. 2, the air dryer cartridge 102 includes passages configured to route untreated air received from the compressed-air system component 104 into the desiccant assembly 202, and further configured to route treated air from the desiccant assembly 202 back to the compressed-air system component 104.

The air dryer cartridge 102 is removably attached to the compressed-air system component 104 via threaded members 208, 210 respectively deployed on the air dryer cartridge 102 and compressed-air system component 104. As best shown in FIG. 3, engagement of the threaded members 208, 210 provides a threaded connection 302. In the illustrated example, a first threaded member 208 is a constituent of the cartridge mounting plate 204 and includes a plurality of female threads, whereas a second threaded member 210 is a constituent of the compressed-air system component 104 and includes a plurality of male threads, where the plurality of male and female threads are configured to be threadably engageable with each other, as shown. As generally known in the art, it is appreciated that the disposition of the male and female threads shown in FIGS. 2 and 3 may be reversed, i.e., first and second threaded members 208, 210 may respectively comprise pluralities of male and female threads.

In a typical air dryer system 100, the cartridge mount plate 204 is fabricated from a first material whereas the compressed-air system component 104 is fabricated from a second material, where the first and second materials have different strengths (i.e., different modulus of elasticity values or yield strengths). More particularly, the first material typically has a strength that is higher than the second material, as in the case, by way of non-limiting example, in which the cartridge mount plate 204 is fabricated from steel whereas the compressed-air system component 104 is fabricated from aluminum.

As further known in the art, the air provided to the air dryer system 100 is typically supplied at pressures well above atmospheric pressure such that the threaded connection 302 provided between the dryer cartridge 102 and the compressed-air system component 104 is repeatedly exposed to significant stress. Such stress, in combination with the above-described accidental overtightening and disparity in material strengths, can lead to premature failure of the threaded connection 302 (particularly those threads formed of the lower strength material), which in turn can lead to the sudden and potentially dangerous ejection of the air dryer cartridge 102.

To address this, U.S. Pat. No. 7,997,842 (“the '842 patent”) proposes various specific thread forms. In particular, the thread forms disclosed in the '842 patent are configured to better ensure line contact between corresponding male and female threads, notwithstanding any manufacturing variances in individual threads that might otherwise lead to uneven load distributions among the plurality of threads, which could eventually lead to failure of the threaded connection. A shortcoming of this approach, however, particularly in applications in which relatively high loads are repeatedly applied to the threaded connection, is that the line contacts between threads can lead to correspondingly high contact stresses within the threads. Such repeated, high contact stress can once again lead to premature failure of the threads.

Thus, techniques that overcome the above-described challenges would be a welcome addition to the art.

### SUMMARY

The above-described shortcomings are addressed through the provision of a thread form of a first plurality of threads of a first threaded member for a threaded connection with a second plurality of threads of a second threaded member. The first plurality of threads has a pitch, P, and each thread of the first plurality of threads includes a crest between a pair of flanks. In a first embodiment, for each thread of the first plurality of threads, a load-bearing flank of the pair of flanks is configured to bear against a mating flank of one of the second plurality of threads and comprises a surface having a first radius, R1, where0.67≤R1/P≤0.80.

In an embodiment, the surface having the first radius is configured to establish an area of contact with the mating flank.

In an embodiment, the first threaded member is a female threaded member and the second threaded member is a male threaded member. Alternatively, the first threaded member is a male threaded member and the second threaded member is a female threaded member. Regardless, the first threaded member may be a constituent of an air dryer cartridge and the second threaded member a constituent of a vehicle air dryer.

In an embodiment, the crest of each thread of the first plurality of threads comprises a surface extending parallel to a longitudinal axis of the first threaded member.

In an embodiment, at least a portion of the surface of the load-bearing flank has an angle, θ1, relative to a line orthogonal to a longitudinal axis of the first threaded member, where 21°≤|θ1|≤23°.

In an embodiment, the pair of flanks of each thread of the first plurality of threads terminates in a portion of a corresponding root, wherein the portion of each corresponding root comprises a surface having a second radius, R2, and where R2/P=0.17.

In an embodiment, for each thread of the first plurality of threads, a flank of the pair of flanks opposite the load-bearing flank comprises a surface having a third radius, R3, where 0.4≤R3/P≤0.53. Further, the at least a portion of the surface of the flank opposite the load-bearing flank may have an angle, θ2, relative to a line orthogonal to a longitudinal axis of the first threaded member, where 9°≤θ2≤11°.

In a second embodiment, a ratio AG/AT is greater than 0.83, where AG is a cross-sectional area of each gap between the first plurality of threads and AT is a cross-sectional area of each thread of the first plurality of threads.

In an embodiment, the second plurality of threads are M39 threads.

In an embodiment, the pitch is 1.5 mm.

In an embodiment, the first threaded member is formed of a first material having a strength different from a second material forming the second threaded member. In such an embodiment, strength of the first material may be greater than strength of the second material. Furthermore, in another embodiment, the first material is steel and the second material is aluminum.

In an embodiment, an apparatus may comprise a thread form as described herein, which apparatus may comprise an air dryer cartridge.

### BRIEF DESCRIPTION OF THE DRAWINGS

The foregoing and other features and advantages will be discussed in detail in the following non-limiting description of specific embodiments in connection with the accompanying drawings, in which:

FIGS. 1 and 2 are respective perspective and exploded views of an air dryer cartridge in the context of an air dryer system in accordance with prior art techniques;

FIG. 3 is a cross-sectional view a threaded connection between a mounting plate of an air dryer cartridge and a compressed-air system component in accordance with prior art techniques;

FIG. 4 is an enlarged cross-sectional view of a portion of a thread form in accordance with the instant disclosure;

FIG. 5 is an enlarged cross-sectional view of a portion of a thread form in accordance with the instant disclosure in assembled condition with a thread form as taught in the '842 patent; and

FIG. 6 is an enlarged cross-sectional view of a portion of a thread form in accordance with the instant disclosure in threaded engagement with an ISO compliant thread form.

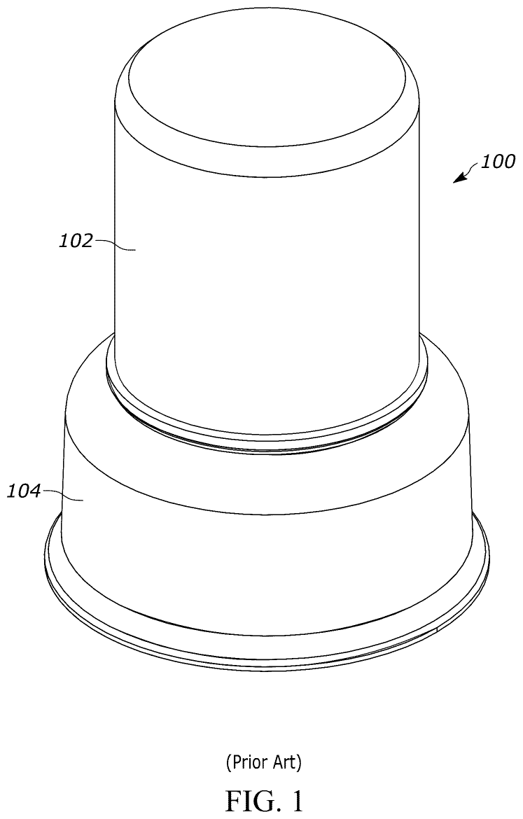

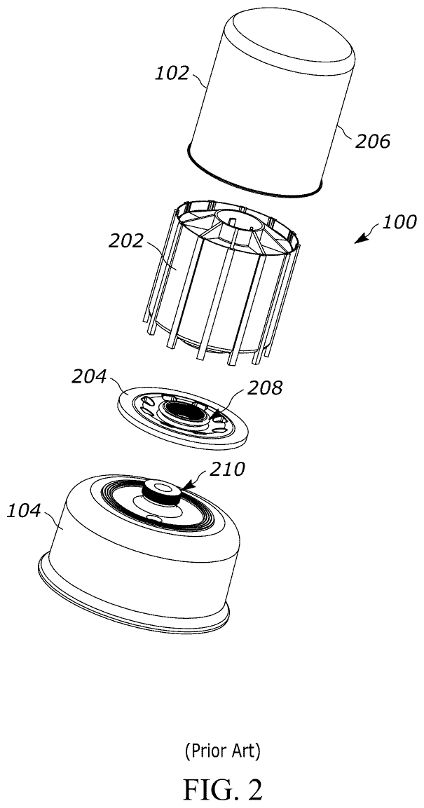

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, expressions establishing equality between values, or the term “substantially” or similar words requiring subjective comparison, are intended to mean “within manufacturing tolerances” unless stated (e.g., through ranges) or implied by context otherwise.

As used herein, the phrase “operatively connected” refers to at least a functional relationship between two elements and may encompass configurations in which the two elements are directly connected to each other, i.e., without any intervening elements, or indirectly connected to each other, i.e., with intervening elements.

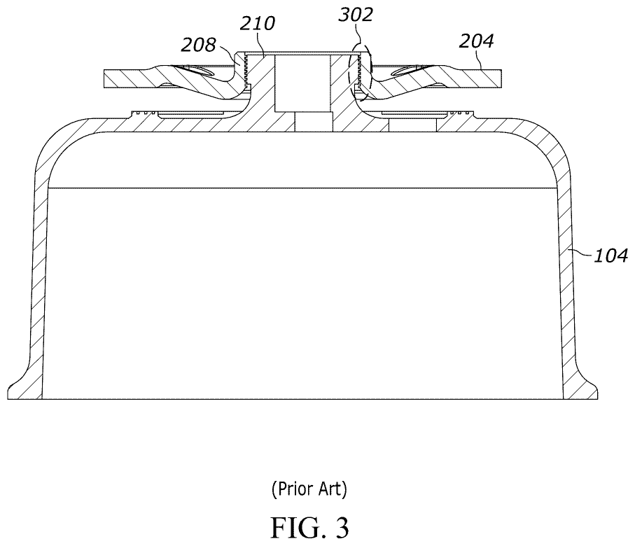

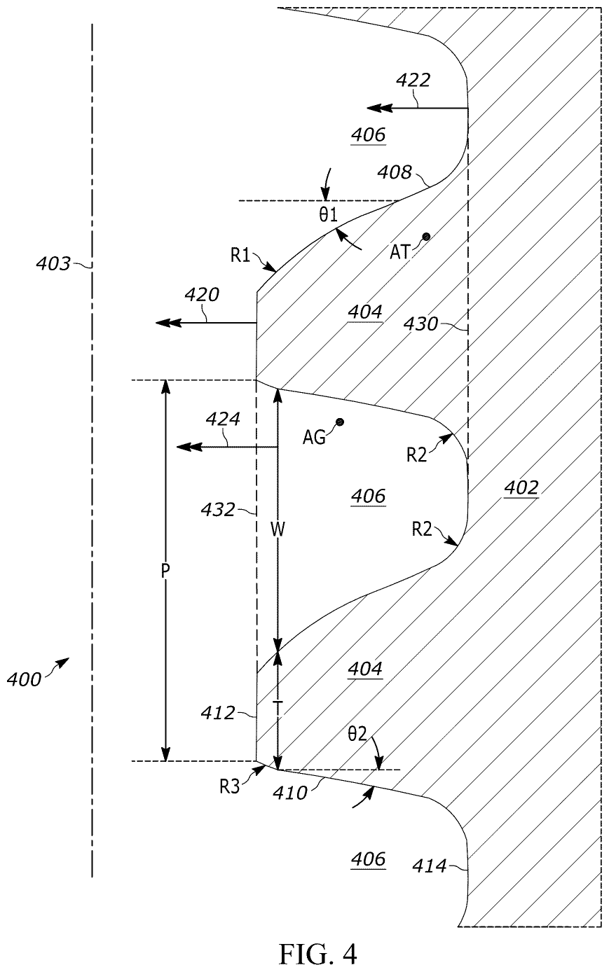

Referring now to FIG. 4, a cross-sectional view of a thread form 400 in accordance with the instant disclosure is illustrated. In the illustrated embodiment, the thread form 400 is fashioned as female threads formed in a threaded member 402. For example, the thread form 400 could be used as the female threads deployed on the cartridge mounting plate 204 as shown in FIG. 3. The threaded member 402 has a central longitudinal axis 403 that is substantially coincident with a central longitudinal axis of a male threaded member (not shown) when the female threaded member 402 it threadedly engaged with the male threaded member. It is understood that the female thread form 400 illustrated in FIG. 4 can be equally applied as male threads on a threaded member.

The thread form 400 comprises a plurality of threads 404 separated by corresponding gaps 406. Each thread 404 comprises a crest 412 between a load bearing flank 408 and an opposite flank 410 (in the sense of on the opposite side of the thread 404 relative to the load bearing flank 408). Each of the flanks 408, 410 terminates in a root 414. As known in the art, the crest 412 of each thread 404 defines a minor diameter 420 of the thread form 400, whereas the root 414 defines a major diameter 422 of the thread form 400. In an embodiment, the crest 412 of each thread 404 comprises a surface (terminated by the respective flanks 408, 410) that extends substantially parallel to the longitudinal axis 403. The threads have a pitch, P, whereas, at a pitch diameter 424 as described in further detail below, each thread 404 has a thickness, T, and each gap 406 has a width, W.

In a presently preferred embodiment, the major diameter 422 of the thread form 400 may be 39 mm. However, those skilled in the art will appreciate that the major diameter 422 may take any of a number of values as a matter of design choice dependent on the particular application at hand.

A feature of the thread form 400 is that each load bearing flank 408 comprises a surface, preferably adjacent to the corresponding crest 412, having a first radius, R1 that meets the condition:

0.67≤R1/P≤0.80 Eq. 1

Thus, for example, where the pitch, P, is 1.5 mm, the first radius, R1, may be within the range the range 1.0 mm≤R1≤1.2 mm. By making the first radius, R1, relatively large as compared to the pitch, P, yet not so large as to make the entire surface of the load bearing flank 408 essentially flat, the load bearing flanks 408 are able to establish relatively broader areas of contact (as opposed to line contact) with mating flanks of a complementary threaded member. As further shown in FIG. 4, at least a portion of the surface of the load bearing flank 408, preferably substantially linear and adjacent the root 414, is formed at a first angle, θ1, relative to a line orthogonal to the longitudinal axis 403, where the first angle, θ1, meets the condition:

21°≤|θ1|≤23° Eq. 2

In an embodiment, and as shown in FIG. 4, the root 414 is defined by opposite portions have a second radius, R2, which portions terminate a corresponding load bearing flank 408 of one thread and an opposite flank 410 of an adjacent thread. In an embodiment, the second radius, R2, meets the condition:

R2/P=0.17 Eq. 3

Thus, for example, where the pitch, P, is 1.5 mm, the second radius, R1, may be 0.25 mm.

Similar to the load bearing flank 408, the opposite flank 410 of each thread 404 comprises a surface, preferably adjacent to the corresponding crest 412, having a third radius, R3 that meets the condition:

0.4≤R3/P≤0.53 Eq. 4
Thus, for example, where the pitch, P, is 1.5 mm, the third radius, R3, may be within the range the range 0.6 mm≤R1≤0.8 mm. As further shown in FIG. 4, at least a portion of the surface of the opposite flank 408, preferably substantially linear and adjacent the root 414, is formed at a second angle, θ2, relative to a line orthogonal to the longitudinal axis 403, where the second angle, θ2, meets the condition:

9°≤Θ2≤11° Eq. 5

It is noted that, although the above-described examples described a pitch value of 1.5 mm, this is a not a requirement. For example, in an embodiment, the pitch value may be within the range of 1.0 mm to 3.0 mm (inclusive). However, those skilled in the art will appreciate the still further pitch values may be equally employed.

Further features of the thread form 400 include the thickness, T, of each thread 404, the width, W, of each gap 406 and corresponding cross-sectional areas of AT, AG of the threads 404 and gaps 406, respectively. As known in the art, the pitch diameter 424 is normally defined as the diameter of an imaginary cylinder that passes through the threads 404 at a point where the thickness, T, of the threads 404 equals the width, W, of the gaps 406 between the threads 404. For purposes of comparison with the thread form 400 of the instant disclosure, the pitch diameter 424 shown in FIG. 4 corresponds to a diameter meeting this definition for a standard thread, e.g., a thread according to the well-known ISO standard. However, in accordance with the instant disclosure, the thread thickness, T, and width, W, for the illustrated thread form 400 are not equal at the pitch diameter 424, as depicted in FIG. 4.

These thickness, T, and width, W, dimensions give rise to differing cross sectional areas for the threads 404 and gaps 406. That is, as shown in FIG. 4, each thread 404 has a cross-sectional area, AT, defined relative to an imaginary line 430 spanning the longitudinal length of the thread to each adjacent root 414. Similarly, each gap 406 has a cross-sectional area, AG, defined relative to an imaginary line 432 spanning the longitudinal distance between a point where the load bearing flank 408 of one thread terminates in its corresponding crest to another point where the opposite flank 410 of an adjacent thread terminates in its corresponding crest, as shown. In an embodiment, an area ratio of AG/AT is greater than 0.83.

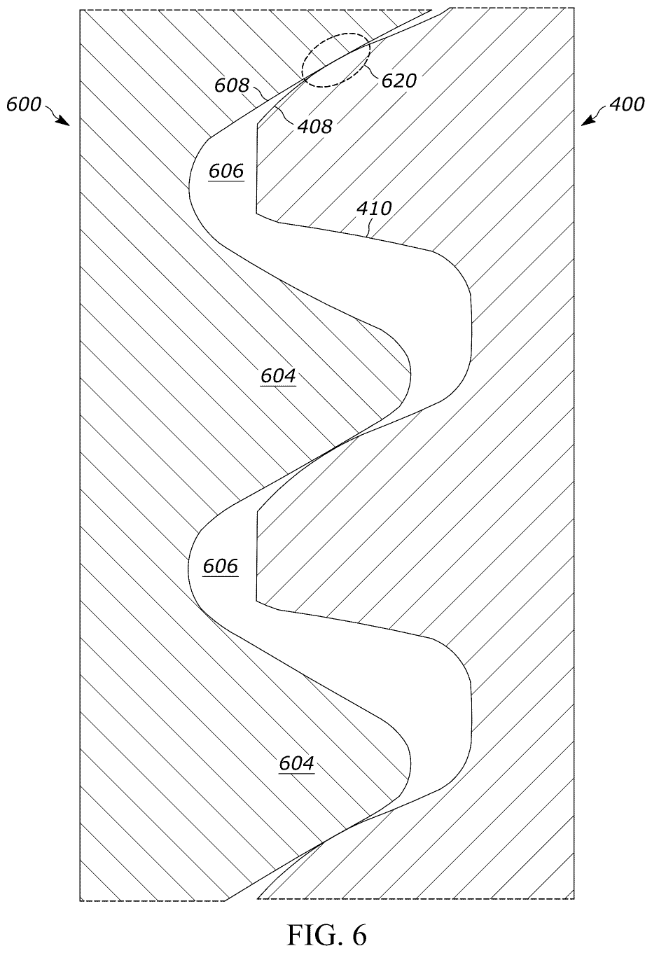

Referring now to FIGS. 6 and 7, the female thread form 400 of FIG. 4 is illustrated in an assembled condition (i.e., threadably engaged) with a male thread form 500 in accordance with the '842 patent and with a male thread form 600 in accordance with the ISO standard, respectively. In the illustrated examples, the female thread form 400 has a material strength that is greater than a material strength of the male thread forms 500, 600. For example, the female thread form 400 may be fabricated from steel whereas the male thread forms 500, 600 may be fabricated from aluminum.

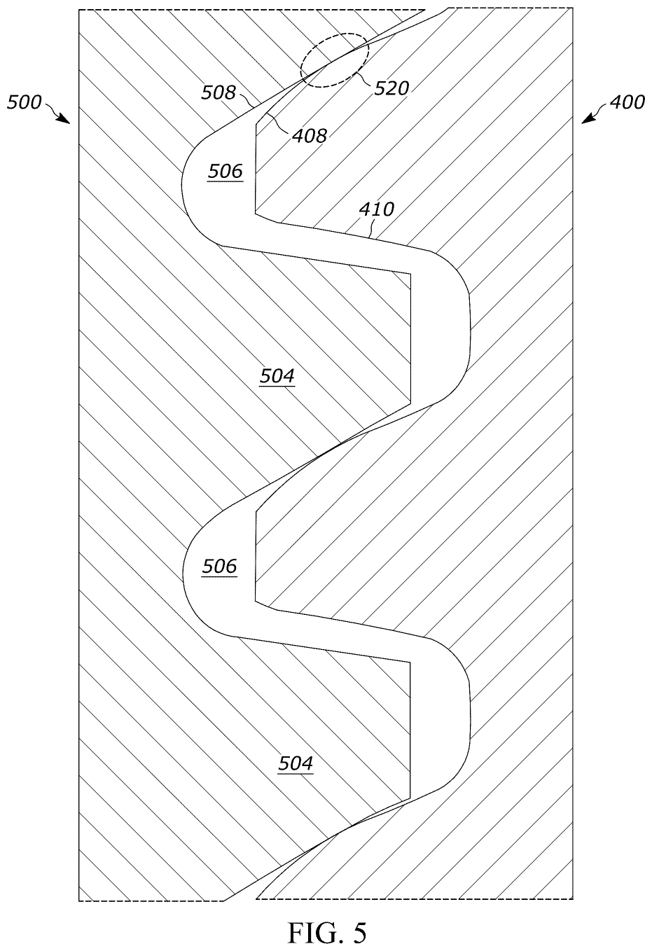

In particular, the male thread form 500 in accordance with the '842 patent has relatively large threads 504 as compared to its gaps 506, whereas the male thread form 600 in accordance with the ISO standard has substantially equal sized threads 604 and gaps 606. Regardless of whether the male thread form assembled with the presently disclosed thread form 400 conforms with the '842 patent or the ISO standard, FIGS. 5 and 6 illustrate that the load bearing flank 408 establishes an area of contact (sometimes referred to as patch contact) 520, 620 with a mating flank 508, 608 in complementary male thread form 500, 600. By providing an area of contact, as opposed to line contact, contact stresses between each load bearing flank 408 and its corresponding mating flank 508, 608 are spread over a larger area and are therefore less likely to reach potentially damage-inducing levels.

For example, in finite element analysis (FEA) simulations, the female thread form 400 is formed in a threaded member of an air dryer cartridge and the male thread forms 500 in accordance with the '842 patent are formed in a threaded member of a compressed-air system component, as described previously. Assuming typical preload forces on the female and male thread forms 400, 500 resulting from their threaded engagement, as well as the loads placed on the resulting threaded connection in accordance with typical air pressures applied to the air dryer cartridge, peak stress levels were determined. For comparison, similar FEA simulations were developed based on threaded engagement of the male and female thread forms described in the '842 patent, which are described therein as being configured to establish line contact. Based on these simulations, the maximum stress at the areas of contact between the presently described thread form 400 and the male thread forms 500 in accordance with the '842 patent were reduced by more than 50% as compared to the maximum stress experienced at the points of line contact between the male and female threads according to the '842 patent.

While the various embodiments in accordance with the instant disclosure have been described in conjunction with specific implementations thereof, it is evident that many alternatives, modifications and variations will be apparent to those skilled in the art. For example, throughout the description above, the presently described thread form has been described in the context of a replaceable cartridge such as an air dryer cartridge for use in commercial vehicle systems. However, it is understood that the presently described thread form may be equally applied to other apparatuses, which apparatuses may exist outside the context of commercial vehicle systems. Accordingly, the preferred embodiments of the invention as set forth herein are intended to be illustrative only and not limiting so long as the variations thereof come within the scope of the appended claims and their equivalents.

What is claimed is:

1. A thread form of a first plurality of threads of a first threaded member for a threaded connection with a second plurality of threads of a second threaded member, the thread form comprising:
the first plurality of threads having a pitch, P, each thread of the first plurality of threads including a crest between a pair of flanks,
wherein, for each thread of the first plurality of threads, a load-bearing flank of the pair of flanks, configured to bear against a mating flank of one of the second plurality of threads, comprises a surface having a first radius, R1, where 0.67≤R1/P≤0.80.

2. The thread form of claim 1, wherein the surface having the first radius is configured to establish an area of contact with the mating flank.

3. The thread form of claim 1, wherein the first threaded member is a female threaded member and the second threaded member is a male threaded member.

4. The thread form of claim 3, wherein the first threaded member is a constituent of an air dryer cartridge and the second threaded member is a constituent of a vehicle air dryer.

5. The thread form of claim 1, wherein the first threaded member is a male threaded member and the second threaded member is a female threaded member.

6. The thread form of claim 5, wherein the first threaded member is a constituent of an air dryer cartridge and the second threaded member is a constituent of a vehicle air dryer.

7. The thread form of claim 1, wherein at least a portion of the surface of the load-bearing flank has an angle, θ1, relative to a line orthogonal to a longitudinal axis of the first threaded member, where 21°≤|θ1|≤23°.

8. The thread form of claim 1, wherein the pair of flanks of each thread of the first plurality of threads terminates in a portion of a corresponding root, and wherein the portion of each corresponding root comprises a surface having a second radius, R2, where R2/P=0.17.

9. The thread form of claim 1, wherein, for each thread of the first plurality of threads, a flank of the pair of flanks opposite the load-bearing flank comprises a surface having a third radius, R3, where 0.4≤R3/P≤0.53.

10. The thread form of claim 9, wherein at least a portion of the surface of the flank opposite the load-bearing flank has an angle, θ2, relative to a line orthogonal to a longitudinal axis of the first threaded member, where 9°≤θ2 ≤11°.

11. The thread form of claim 1, wherein an area ratio AG/AT>0.83, where AG is a cross-sectional area of each gap between the first plurality of threads and AT is a cross-sectional area of each thread of the first plurality of threads.

12. The thread form of claim 1, wherein the second plurality of threads are M39 threads.

13. The thread form of claim 1, wherein the pitch is 1.5 mm.

14. The thread form of claim 1, wherein the first threaded member is formed of a first material having a strength different from a second material forming the second threaded member.

15. The thread form of claim 14, wherein strength of the first material is greater than strength of the second material.

16. The thread form of claim 15, wherein the first material is steel and the second material is aluminum.

17. An apparatus comprising the thread form of claim 1.

18. The apparatus of claim 17, wherein the apparatus is an air dryer cartridge.

19. A thread form of a first plurality of threads of a first threaded member for a threaded connection with a second plurality of threads of a second threaded member, the thread form comprising:
the first plurality of threads having a pitch, P, each thread of the first plurality of threads including a crest between a pair of flanks,
wherein an area ratio AG/AT>0.83, where AG is a cross-sectional area of each gap between the first plurality of threads and AT is a cross-sectional area of each thread of the first plurality of threads.

20. The thread form of claim 19, wherein the first threaded member is a female threaded member and the second threaded member is a male threaded member.

21. The thread form of claim 20, wherein the first threaded member is a constituent of an air dryer cartridge and the second threaded member is a constituent of a vehicle air dryer.

22. The thread form of claim 21, wherein the first threaded member is a male threaded member and the second threaded member is a female threaded member.

23. The thread form of claim 22, wherein the first threaded member is a constituent of an air dryer cartridge and the second threaded member is a constituent of a vehicle air dryer.

24. The thread form of claim 19, wherein the second plurality of threads are M39 threads.

25. The thread form of claim 19, wherein the pitch is 1.5 mm.

26. The thread form of claim 19, wherein the first threaded member is formed of a first material having a strength different from a second material forming the second threaded member.

27. The thread form of claim 26, wherein strength of the first material is greater than strength of the second material.

28. The thread form of claim 27, wherein the first material is steel and the second material is aluminum.

29. An apparatus comprising the thread form of claim 19.

30. The apparatus of claim 29, wherein the apparatus is an air dryer cartridge.
